(19) United States
(12) Patent Application Publication
(10) Pub. No.: US 2025/0298684 A1
(43) Pub. Date: Sep. 25, 2025

(54) SYSTEM AND METHOD FOR ENHANCING TOTAL CUSTOMER EXPERIENCE IN IT INCIDENT RESOLUTION

(71) Applicant: Amit Mangal, Shrewsbury, MA (US)

(72) Inventor: Amit Mangal, Shrewsbury, MA (US)

(21) Appl. No.: 18/609,026

(22) Filed: Mar. 19, 2024

(51) Int. Cl. G06F 11/07; G06Q 10/10; G06Q 10/1093; H04L 51/046

(52) U.S. Cl. CPC G06F 11/0793; G06Q 10/103; G06Q 10/1095; H04L 51/046

(57) ABSTRACT

The present invention relates to an AI-enabled utility plug-in for IT incident management tools that improves total customer experience (TCE) by streamlining the resolution process for complex incidents. The plug-in detects when an incident has been reassigned multiple times and temporarily prevents further reassignment. It identifies the earliest available time slot for a meeting among the respective stakeholders and automatically schedules the meeting to determine incident ownership and resolution steps. The plug-in updates the IT incident management tool with the determined ownership and steps, and triggers notifications to higher-level authorities if no resolution is reached. The invention also includes features such as analyzing incident complexity, maintaining a knowledge base, providing real-time notifications, generating efficiency reports, integrating with communication platforms, offering a user interface, and defining escalation rules. By improving collaboration, clarity, and efficiency in handling complex IT incidents, the AI-enabled utility plug-in enhances TCE and optimizes the overall IT incident management process.

### FIELD OF THE DISCLOSURE

The present invention relates to an AI-enabled utility plug-in for IT incident management lifecycle tools. Specifically, it provides a systematic and methodical approach to improve total customer experience (TCE) by expediting the resolution of complex IT incidents that require multiple teams and have ambiguous ownership, thereby reducing bouncing of incidents between teams and ensuring timely closure.

### BACKGROUND OF THE INVENTION

In today's fast-paced business environment, organizations heavily rely on information technology (IT) services to support their operations and deliver value to customers. When IT incidents occur, it is crucial to resolve them quickly and efficiently to minimize downtime and maintain customer satisfaction. However, the current state of IT incident management processes often falls short in handling complex incidents that involve multiple teams and have ambiguous ownership.

Commonly used IT incident lifecycle management tools lack efficient features to expedite solutions when incidents bounce from one team to another. This lack of coordination and clarity in ownership leads to prolonged resolution times, resulting in frustrated customers and potential breach of service level agreements (SLAs).

The complexity of modern IT infrastructures and the interdependencies between various systems and applications further exacerbate the problem. Incidents that span across multiple domains, such as network, database, application, and storage, require the involvement of different teams with specialized expertise. Without a well-defined process and effective communication channels, these incidents can easily fall into a cycle of being passed around without making significant progress towards resolution.

Moreover, the absence of a centralized system to track and manage the ownership and status of complex incidents contributes to the inefficiency. Teams often work in silos, lacking visibility into the overall progress and the actions taken by other teams. This disconnect leads to duplication of efforts, miscommunication, and delays in resolving the incident.

The impact of prolonged incident resolution extends beyond customer dissatisfaction. It can lead to financial losses due to extended downtime, damage to the organization's reputation, and strain on IT resources. Furthermore, the lack of a streamlined process for handling complex incidents hinders the ability to learn from past experiences and improve the overall incident management lifecycle.

In light of these challenges, there is a pressing need for a solution that can address the inefficiencies in managing complex IT incidents. An intelligent system that can facilitate collaboration, provide clarity in ownership, and expedite the resolution process is essential to enhance the total customer experience and optimize IT incident management.

### SUMMARY

The present disclosure relates to a system and method for improving total customer experience (TCE) in IT incident management using an AI-enabled utility plug-in for an IT incident management tool. The system comprises an IT incident management tool and an AI-enabled utility plug-in configured to detect when an IT incident has been reassigned to a different team more than a predetermined number of times and temporarily prevent further reassignment. The plug-in identifies the earliest available common time slot for a meeting among the respective stakeholders, automatically schedules a meeting to determine incident ownership and resolution steps, and updates the IT incident management tool accordingly.

The AI-enabled utility plug-in determines if no resolution has been reached after the scheduled meeting and triggers a notification to a higher-level authority for prioritization and resolution. It also identifies if a third-party vendor is required and enables additional fields to capture vendor-related information. The predetermined number of times for reassignment is configurable based on the IT incident management process, and the plug-in provides an option to schedule a second meeting if no resolution is reached during the first meeting.

The plug-in analyzes the complexity of the IT incident based on predefined criteria and dynamically adjusts the predetermined number of times for reassignment. It monitors the status and progress of the resolution, provides real-time notifications regarding delays or deviations, and maintains a knowledge base of historical IT incident data to suggest potential root causes and resolution steps. The plug-in employs machine learning algorithms to improve the accuracy and relevance of suggestions over time.

The AI-enabled utility plug-in integrates with communication platforms to facilitate collaboration and information sharing among stakeholders. It provides a user interface for inputting and updating information related to the IT incident and automatically synchronizes this information with the IT incident management tool. The plug-in defines escalation rules based on the severity and impact of the incident and automatically triggers escalations to ensure prompt attention and resolution of critical incidents.

The method involves detecting when an IT incident has been reassigned more than a predetermined number of times, temporarily preventing further reassignment, identifying the earliest available time slot for a meeting among stakeholders, automatically scheduling a meeting to determine incident ownership and resolution steps, and updating the IT incident management tool. The method includes determining if no resolution has been reached, triggering notifications to higher-level authorities, identifying if a third-party vendor is required, and enabling additional fields for vendor-related information.

The method also involves analyzing the complexity of the IT incident, dynamically adjusting the number of times for reassignment, monitoring the status and progress of the resolution, providing real-time notifications, updating the knowledge base, employing machine learning algorithms, integrating with communication platforms, providing a user interface for updating information, and defining escalation rules to ensure prompt attention and resolution of critical incidents.

### BRIEF DESCRIPTION OF THE DRAWINGS

FIG. 1 is a flowchart illustrating a method for improving total customer experience, according to some embodiments of the present disclosure.

FIG. 2 is a flowchart further illustrating the method for improving total customer experience from FIG. 1, according to some embodiments of the present disclosure.

FIG. 3 is a flowchart further illustrating the method for improving total customer experience from FIG. 1, according to some embodiments of the present disclosure.

FIG. 4 is a flowchart further illustrating the method for improving total customer experience from FIG. 1, according to some embodiments of the present disclosure.

FIG. 5 is a flowchart further illustrating the method for improving total customer experience from FIG. 1, according to some embodiments of the present disclosure.

FIG. 6 is a flowchart further illustrating the method for improving total customer experience from FIG. 1, according to some embodiments of the present disclosure.

FIG. 7 is a flowchart further illustrating the method for improving total customer experience from FIG. 1, according to some embodiments of the present disclosure.

### DETAILED DESCRIPTION

The present disclosure describes a system for improving total customer experience (TCE) in IT incident management. The system comprises an IT incident management tool and an AI-enabled utility plug-in for the IT incident management tool.

The AI-enabled utility plug-in is configured to detect when an IT incident has been reassigned to a different team more than a predetermined number of times and temporarily prevent further reassignment of the incident. The plug-in identifies the earliest available common time slot for a meeting among the respective stakeholders based on their availability mapped in the IT incident management tool, automatically schedules a meeting with the stakeholders to determine incident ownership and resolution steps, and updates the IT incident management tool with the determined incident ownership and resolution steps.

The plug-in is further configured to determine if no resolution has been reached after the scheduled meeting and automatically trigger a notification to a higher-level authority for prioritization and resolution of the IT incident. It can also identify if a third-party vendor is required for resolving the incident and enable additional fields in the IT incident management tool to capture vendor-related information, such as vendor name, incident number, and status.

The system allows the predetermined number of times for reassignment to be configurable based on the specific requirements of the IT incident management process. The AI-enabled utility plug-in provides an option for a leader to schedule a second meeting with an adjustable duration and participant list if no resolution is reached during the first scheduled meeting.

The plug-in enables a justification field in the IT incident management tool for reassigning the IT incident after the predetermined number of times and allows the reassignment of the incident only if a valid justification is provided and accepted by the new assignee.

The AI-enabled utility plug-in analyzes the complexity of the IT incident based on predefined criteria, such as the number of teams involved, the technical domains affected, and the impact on business operations. It dynamically adjusts the predetermined number of times for reassignment based on the analyzed complexity of the incident.

The plug-in monitors the status and progress of the IT incident resolution after the meeting and provides real-time notifications to the respective stakeholders and higher-level authorities regarding any delays or deviations from the determined resolution steps. It continuously updates a knowledge base with new IT incident data and employs machine learning algorithms to improve the accuracy and relevance of the suggested root causes and resolution steps over time.

The system maintains a knowledge base of historical IT incident data, including root causes, resolution steps, and associated teams. The AI-enabled utility plug-in suggests potential root causes and resolution steps for the current IT incident based on similarities with historical incidents in the knowledge base.

The plug-in tracks the time spent by each team on the IT incident resolution and generates reports on the efficiency and effectiveness of the IT incident management process, including metrics such as average resolution time, number of reassignments, and customer satisfaction scores.

The AI-enabled utility plug-in integrates with communication platforms, such as email and chat applications, to facilitate seamless collaboration and information sharing among the respective stakeholders during the IT incident resolution process.

The system provides a user interface for the respective stakeholders to input and update information related to the IT incident, such as root cause analysis, impact assessment, and resolution progress. The AI-enabled utility plug-in automatically synchronizes the information entered through the user interface with the IT incident management tool.

The plug-in defines escalation rules based on the severity and impact of the IT incident and automatically triggers escalations to higher-level authorities based on the defined escalation rules, ensuring prompt attention and resolution of critical incidents.

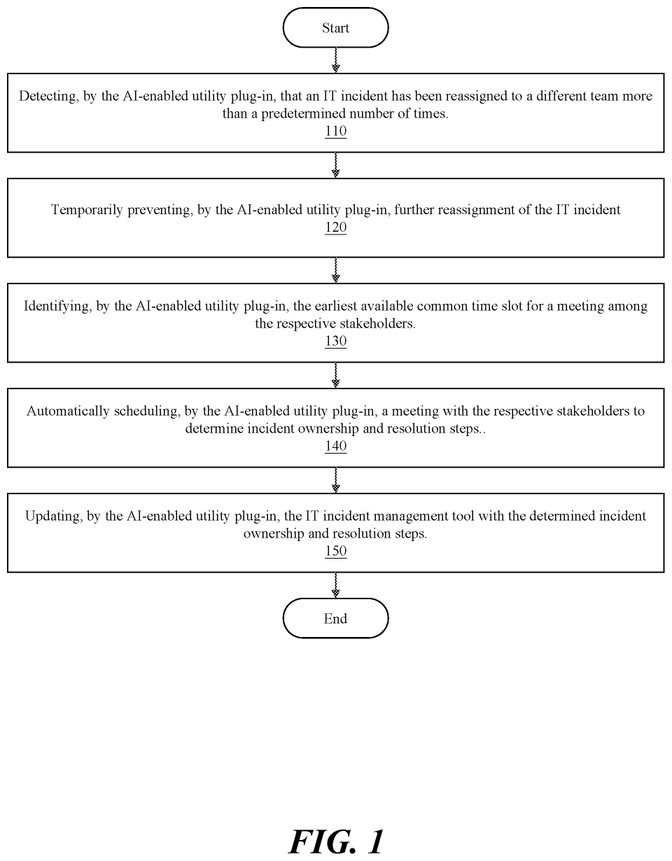

FIG. 1 is a flowchart that describes a method for improving total customer experience, according to some embodiments of the present disclosure. In some embodiments, at 110, the method may include detecting, by the AI-enabled utility plug-in, that an IT incident has been reassigned to a different team more than a predetermined number of times. At 120, the method may include temporarily preventing, by the AI-enabled utility plug-in, further reassignment of the IT incident. At 130, the method may include identifying, by the AI-enabled utility plug-in, the earliest available common time slot for a meeting among the respective stakeholders based on their availability mapped in the IT incident management tool. At 140, the method may include automatically scheduling, by the AI-enabled utility plug-in, a meeting with the respective stakeholders to determine incident ownership and resolution steps. At 150, the method may include updating, by the AI-enabled utility plug-in, the IT incident management tool with the determined incident ownership and resolution steps.

In some embodiments, the predetermined number of times for reassignment may be configurable based on the specific requirements of the IT incident management process. In some embodiments, Providing, by the AI-enabled utility plug-in, an option for a leader to schedule a second meeting with an adjustable duration and participant list if no resolution may be reached during the first scheduled meeting. In some embodiments, the method may include providing, by the AI-enabled utility plug-in, real-time notifications to the respective stakeholders and higher-level authorities regarding any delays or deviations from the determined resolution steps. Monitoring, by the AI-enabled utility plug-in, the status and progress of the IT incident resolution after the meeting.

In some embodiments, the method may include providing, by the AI-enabled utility plug-in, real-time notifications to the respective stakeholders and higher-level authorities regarding any delays or deviations from the determined resolution steps. Monitoring, by the AI-enabled utility plug-in, the status and progress of the IT incident resolution after the meeting. In some embodiments, the method may include generating, by the AI-enabled utility plug-in, reports on the efficiency and effectiveness of the IT incident management process, including metrics such as average resolution time, number of reassignments, and customer satisfaction scores. Tracking, by the AI-enabled utility plug-in, the time spent by each team on the IT incident resolution.

In some embodiments, Integrating, by the AI-enabled utility plug-in, with communication platforms, such as email and chat applications, to facilitate seamless collaboration and information sharing among the respective stakeholders during the IT incident resolution process. In some embodiments, the method may include providing, by the AI-enabled utility plug-in, a user interface for the respective stakeholders to input and update information related to the IT incident, including root cause analysis, impact assessment, and resolution progress. Automatically synchronizing, by the AI-enabled utility plug-in, the information entered through the user interface with the IT incident management tool.

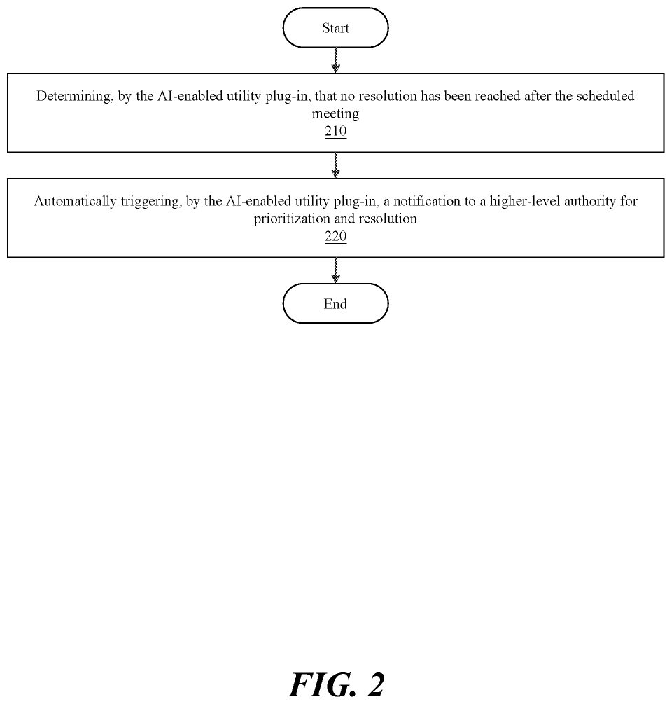

FIG. 2 is a flowchart that further describes the method for improving total customer experience from FIG. 1, according to some embodiments of the present disclosure. In some embodiments, at 210, the method may include determining, by the AI-enabled utility plug-in, that no resolution has been reached after the scheduled meeting. At 220, the method may include automatically triggering, by the AI-enabled utility plug-in, a notification to a higher-level authority for prioritization and resolution of the IT incident.

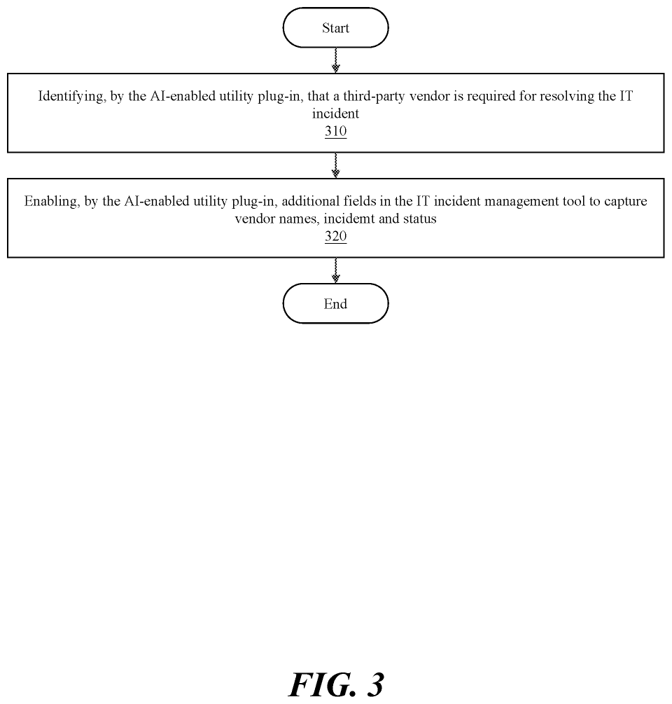

FIG. 3 is a flowchart that further describes the method for improving total customer experience from FIG. 1, according to some embodiments of the present disclosure. In some embodiments, at 310, the method may include identifying, by the AI-enabled utility plug-in, that a third-party vendor may be required for resolving the IT incident. At 320, the method may include enabling, by the AI-enabled utility plug-in, additional fields in the IT incident management tool to capture vendor-related information, including vendor name, incident number, and status.

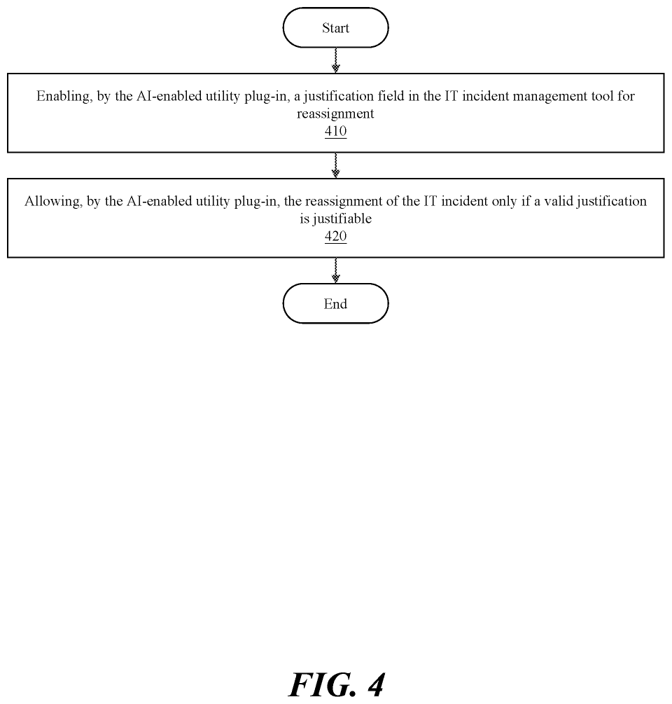

FIG. 4 is a flowchart that further describes the method for improving total customer experience from FIG. 1, according to some embodiments of the present disclosure. In some embodiments, at 410, the method may include enabling, by the AI-enabled utility plug-in, a justification field in the IT incident management tool for reassigning the IT incident after the predetermined number of times. At 420, the method may include allowing, by the AI-enabled utility plug-in, the reassignment of the IT incident only if a valid justification may be provided and accepted by the new assignee.

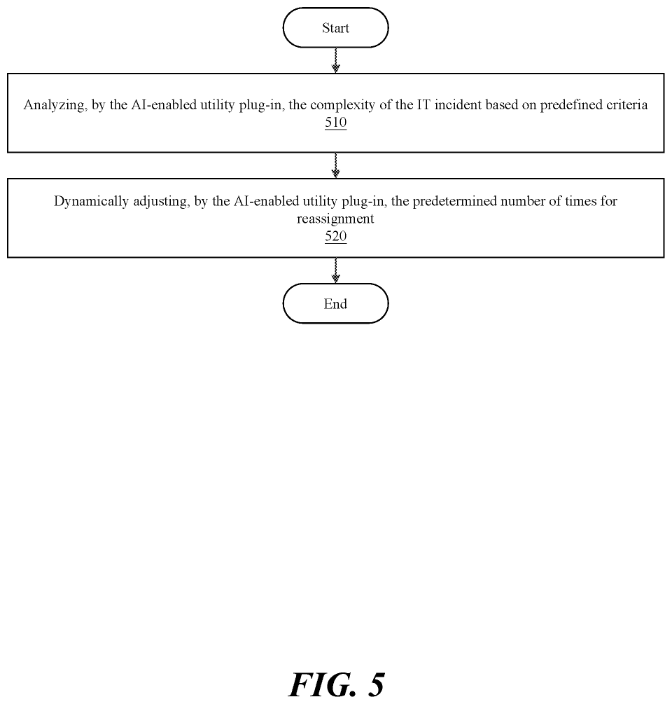

FIG. 5 is a flowchart that further describes the method for improving total customer experience from FIG. 1, according to some embodiments of the present disclosure. In some embodiments, at 510, the method may include analyzing, by the AI-enabled utility plug-in, the complexity of the IT incident based on predefined criteria, including the number of teams involved, the technical domains affected, and the impact on business operations. At 520, the method may include dynamically adjusting, by the AI-enabled utility plug-in, the predetermined number of times for reassignment based on the analyzed complexity of the IT incident.

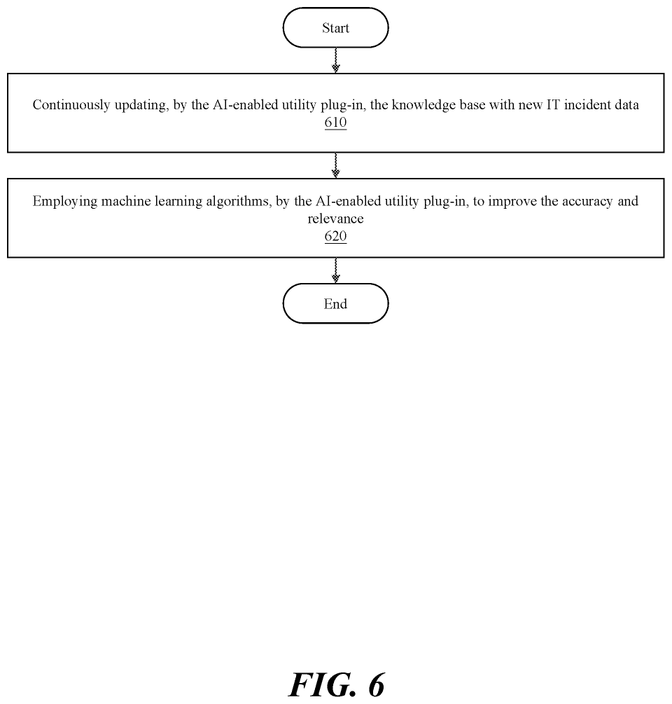

FIG. 6 is a flowchart that further describes the method for improving total customer experience from FIG. 1, according to some embodiments of the present disclosure. In some embodiments, at 610, the method may include continuously updating, by the AI-enabled utility plug-in, the knowledge base with new IT incident data. At 620, the method may include employing machine learning algorithms, by the AI-enabled utility plug-in, to improve the accuracy and relevance of the suggested root causes and resolution steps over time.

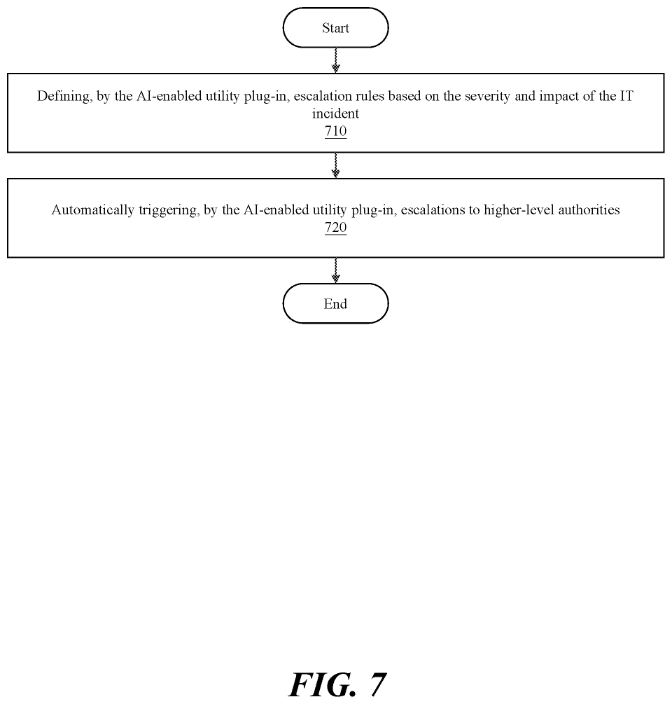

FIG. 7 is a flowchart that further describes the method for improving total customer experience from FIG. 1, according to some embodiments of the present disclosure. In some embodiments, at 710, the method may include defining, by the AI-enabled utility plug-in, escalation rules based on the severity and impact of the IT incident. At 720, the method may include automatically triggering, by the AI-enabled utility plug-in, escalations to higher-level authorities based on the defined escalation rules, ensuring prompt attention and resolution of critical incidents.

What is claimed is:

1. A method for improving total customer experience (TCE) in IT incident management using an AI-enabled utility plug-in for an IT incident management tool, the method comprising:
detecting, by the AI-enabled utility plug-in, that an IT incident has been reassigned to a different team more than a predetermined number of times;
temporarily preventing, by the AI-enabled utility plug-in, further reassignment of the IT incident;
identifying, by the AI-enabled utility plug-in, the earliest available common time slot for a meeting among the respective stakeholders based on their availability mapped in the IT incident management tool;
automatically scheduling, by the AI-enabled utility plug-in, a meeting with the respective stakeholders to determine incident ownership and resolution steps; and
updating, by the AI-enabled utility plug-in, the IT incident management tool with the determined incident ownership and resolution steps.

2. The method of claim 1, further comprising:
determining, by the AI-enabled utility plug-in, that no resolution has been reached after the scheduled meeting; and
automatically triggering, by the AI-enabled utility plug-in, a notification to a higher-level authority for prioritization and resolution of the IT incident.

3. The method of claim 1, further comprising:
identifying, by the AI-enabled utility plug-in, that a third-party vendor is required for resolving the IT incident; and
enabling, by the AI-enabled utility plug-in, additional fields in the IT incident management tool to capture vendor-related information, including vendor name, incident number, and status.

4. The method of claim 1, wherein the predetermined number of times for reassignment is configurable based on the specific requirements of the IT incident management process.

5. The method of claim 1, further comprising providing, by the AI-enabled utility plug-in, an option for a leader to schedule a second meeting with an adjustable duration and participant list if no resolution is reached during the first scheduled meeting.

6. The method of claim 1, further comprising:
enabling, by the AI-enabled utility plug-in, a justification field in the IT incident management tool for reassigning the IT incident after the predetermined number of times; and
allowing, by the AI-enabled utility plug-in, the reassignment of the IT incident only if a valid justification is provided and accepted by the new assignee.

7. The method of claim 1, further comprising:
analyzing, by the AI-enabled utility plug-in, the complexity of the IT incident based on predefined criteria, including the number of teams involved, the technical domains affected, and the impact on business operations; and
dynamically adjusting, by the AI-enabled utility plug-in, the predetermined number of times for reassignment based on the analyzed complexity of the IT incident.

8. The method of claim 1, further comprising:
monitoring, by the AI-enabled utility plug-in, the status and progress of the IT incident resolution after the meeting; and
providing, by the AI-enabled utility plug-in, real-time notifications to the respective stakeholders and higher-level authorities regarding any delays or deviations from the determined resolution steps.

9. The method of claim 1, further comprising:
monitoring, by the AI-enabled utility plug-in, the status and progress of the IT incident resolution after the meeting; and
providing, by the AI-enabled utility plug-in, real-time notifications to the respective stakeholders and higher-level authorities regarding any delays or deviations from the determined resolution steps.

10. The method of claim 1, further comprising:
continuously updating, by the AI-enabled utility plug-in, the knowledge base with new IT incident data; and
employing machine learning algorithms, by the AI-enabled utility plug-in, to improve the accuracy and relevance of the suggested root causes and resolution steps over time.

11. The method of claim 1, further comprising:
tracking, by the AI-enabled utility plug-in, the time spent by each team on the IT incident resolution; and
generating, by the AI-enabled utility plug-in, reports on the efficiency and effectiveness of the IT incident management process, including metrics such as average resolution time, number of reassignments, and customer satisfaction scores.

12. The method of claim 1, further comprising integrating, by the AI-enabled utility plug-in, with communication platforms, such as email and chat applications, to facilitate seamless collaboration and information sharing among the respective stakeholders during the IT incident resolution process.

13. The method of claim 1, further comprising:
providing, by the AI-enabled utility plug-in, a user interface for the respective stakeholders to input and update information related to the IT incident, including root cause analysis, impact assessment, and resolution progress; and
automatically synchronizing, by the AI-enabled utility plug-in, the information entered through the user interface with the IT incident management tool.

14. The method of claim 1, further comprising:
defining, by the AI-enabled utility plug-in, escalation rules based on the severity and impact of the IT incident; and
automatically triggering, by the AI-enabled utility plug-in, escalations to higher-level authorities based on the defined escalation rules, ensuring prompt attention and resolution of critical incidents.
